(19) United States
(12) Patent Application Publication
(10) Pub. No.: US 2007/0079004 A1
(43) Pub. Date: Apr. 5, 2007

(54) Method and apparatus for distributed indexing

(76) Inventors: Junichi Tatemura, (US); Kasim Selcuk Candan, (US); Liping Chen, (US); Divyakant Agrawal, (US); Dirceu Cavendish, (US)

Correspondence Address: NEC LABORATORIES AMERICA, INC., 4 INDEPENDENCE WAY, PRINCETON, NJ, 08540, US

(21) Appl. No.: 11/240,068

(22) Filed: Sep. 30, 2005

(51) Int. Cl. G06F 15/173

(52) U.S. Cl. 709/238

(57) ABSTRACT

Disclosed is a method and apparatus for providing range based queries over distributed network nodes. Each of a plurality of distributed network nodes stores at least a portion of a logical index tree. The nodes of the logical index tree are mapped to the network nodes based on a hash function. Load balancing is addressed by replicating the logical index tree nodes in the distributed physical nodes in the network. In one embodiment the logical index tree comprises a plurality of logical nodes for indexing available resources in a grid computing system. The distributed network nodes are broker nodes for assigning grid computing resources to requesting users. Each of the distributed broker nodes stores at least a portion of the logical index tree.

### BACKGROUND OF THE INVENTION

The present invention relates generally to computer index systems, and more particularly to a method and apparatus for distributing an index over multiple network nodes.

Grid computing is the simultaneous use of networked computer resources to solve a problem. In most cases, the problem is a scientific or technical problem that requires a great number of computer processing cycles or access to large amounts of data. Grid computing requires the use of software that can divide a large problem into smaller sub-problems, and distribute the sub-problems to many computers. Grid computing can be thought of as distributed and large-scale cluster computing and as a form of network-distributed parallel processing. It can be confined to the computers of a local area network (e.g., within a corporate network) or it can be a worldwide public collaboration using many computers over a wide area network (e.g., the Internet).

One of the critical components of any grid computing system is the information service (also called directory service) component, which is used by grid computing clients to locate available computing resources. Grid resources are a collection of shared and distributed hardware and software made available to the grid clients (e.g., users or applications). These resources may be physical components or software components. For example, resources may include application servers, data servers, Windows/Linux based machines, etc. Most of the currently implemented information services components are based on a centralized design. That is, there is a central information service that maintains lists of available grid resources, receives requests for grid resources from users, and acts as a broker for assigning available resources to requesting clients. While these centralized information service components work relatively well for small and highly specialized grid computing systems, they fail to scale well to systems having more than about 300 concurrent users. Thus, this scalability problem is likely to be an inhibiting factor in the growth of grid computing.

One type of network computing that addresses the scaling issue is peer-to-peer (sometimes referred to as P2P) computing. One well known type of P2P computing is Internet P2P in which a group of computer users with the same networking program can initiate a communication session with each other and directly access files from one another's hard drives. In some cases, P2P communications is implemented by giving each communication node both server and client capabilities. Some existing P2P systems support many client/server nodes, and have scaled to orders of magnitude greater than the 300 concurrent user limit of grid computing. P2P systems have solved the information service component scalability problem by utilizing a distributed approach to locating nodes that store a particular data item. As will be described in further detail below, I. Stoica, R. Morris, D. Karger, M. Kaashoek, H. Balakrishnan, Chord: A Scalable Peer-to-peer Lookup Service for Internet Applications, Proceedings of ACM SIGCOMM, Aug. 27-31, 2001, San Diego, Calif., describes Chord, which is a distributed lookup protocol that maps a given key onto a network node. This protocol may be used to locate data that is stored in a distributed fashion in a network.

There are significant differences between a grid computing system and a P2P system that make it difficult to use the known scalable lookup services of P2P networks (e.g., Chord) as the information service component in a grid computing system. One such significant difference is that grid computing resource requests are range based. That is, resource requests in a grid computing system may request a resource based on ranges of attributes of the resources, rather than specific values of the resource attributes as in the case of a P2P system. For example, a lookup request in a P2P system may include a request for a data file having a particular name. Using a system like Chord, the lookup service may map the name to a particular network data node. However, a resource request in a grid computing system may include a request for a machine having available CPU resources in the range of: 0.1<cpu<0.4, and memory resources in the range of 0.2 mem<0.5 (note that the actual values are not important for the present description, and such values have been normalized to the interval of (0,1] for ease of reference herein). Such range queries are not implementable on the distributed protocol lookup services used for P2P computing systems.

Thus, what is needed is an efficient and scalable technique for providing range based queries over distributed network nodes.

### BRIEF SUMMARY OF THE INVENTION

The present invention provides an improved technique for providing range based queries over distributed network nodes. In one embodiment, a system comprises a plurality of distributed network nodes, with each of the network nodes storing at least a portion of a logical index tree. The nodes of the logical index tree are mapped to the network nodes based on a hash function.

Load balancing is addressed by replicating the logical index tree nodes in the distributed physical nodes in the network. Three different embodiments for such replication are as follows. In a first embodiment of replication, referred to as tree replication, certain ones of the physical nodes contain replicas of the entire logical index tree. In a second embodiment of replication, referred to as path caching, each physical node has a partial view of the logical index tree. In this embodiment, each of the network nodes stores 1) the logical node which maps to the network node and 2) the logical nodes on a path from the logical node to the root node of the logical index tree. In a third embodiment, a node replication technique is used to replicate each internal node explicitly. In this embodiment, the node replication is done at the logical level itself and the number of replicas of any given logical node is proportional to the number of the node's leaf descendants.

One advantageous embodiment of the present invention is for use in a grid computing resource discovery system. In this embodiment, the logical index tree comprises a plurality of logical nodes for indexing available resources in the grid computing system. The system further comprises a network of distributed broker nodes for assigning grid computing resources to requesting users, with each of the distributed broker nodes storing at least a portion of the logical index tree. The logical nodes are mapped to the broker nodes based on a distributed hash function. In this embodiment, load balancing may be achieved by replicating the logical index tree nodes in the distributed broker nodes as described above.

These and other advantages of the invention will be apparent to those of ordinary skill in the art by reference to the following detailed description and the accompanying drawings.

### BRIEF DESCRIPTION OF THE DRAWINGS

FIG. 1 shows a high level block diagram of a computer which may be used to implement the principles of the present invention;

FIG. 2A shows a two dimensional data space containing data points dispersed throughout the data space;

FIG. 2B illustrates a 2-d tree data structure that may be used to logically represent the two dimensional data space shown in FIG. 2A;

FIG. 3 shows an identifier circle;

FIG. 4 shows example finger tables for the example nodes of FIG. 3;

FIG. 5 illustrates the mapping of a logical index tree to distributed physical network nodes using a DHT technique;

FIG. 6 illustrates the mapping of a logical index tree to distributed physical network nodes using a DHT technique;

FIG. 7(a) shows a general representation of a node replication embodiment;

FIG. 7(b) is a graphical illustration showing how a replication graph evolves as the logical index tree expands;

FIG. 8 illustrates a node replication process; and

FIG. 9 shows pseudo code of a computer algorithm to construct a replication graph.

### DETAILED DESCRIPTION

A grid computing system may be considered as including three types of entities: resources, users and a brokering service. Resources are the collection of shared and distributed hardware and software made available to users of the system. The brokering service is the system that receives user requests, searches for available resources meeting the user request, and assigns the resources to the users.

Resources are represented herein by a pair (K,V), where K (key) is a vector of attributes that describe the resource, and V is the network address where the resource is located. For example, a key (K) describing a server resource cold be represented by the vector: (version, CPU, memory, permanent storage). The attributes of the key may be either static attributes or dynamic attributes. The static attributes are attributes relating to the nature of the resource. Examples of static attributes are version, CPU, memory and permanent storage size. Dynamic attributes are those that may change over time for a particular resource. Examples of dynamic attributes are available memory and CPU load). Each attribute is normalized to the interval of (0,1]. A user's request for a resource is issued by specifying a constraint on the resource attributes. Thus, user requests are range queries on the key vector attributes. An example of a user request may be: (CPU>0.3, mem<0.5).

The above described vector of attributes may be modeled as a multidimensional space, and therefore each resource becomes a point in this multidimensional space. Since the attributes include dynamic attributes, over time the resource points will move within the multidimensional space. The overall effectiveness of a brokering service in a grid computing system is heavily dependent upon the effectiveness and efficiency of an indexing scheme which allows the brokering service to find resources in the multidimensional space based on user's range queries.

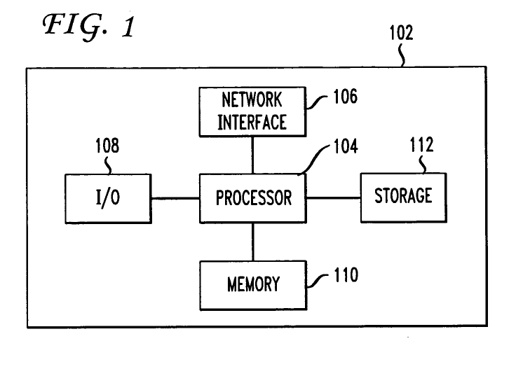

Prior to discussing the various embodiments of the invention, it is noted that the various embodiments discussed below may be implemented using programmable computer systems and data networks, both of which are well known in the art. A high level block diagram of a computer which may be used to implement the principles of the present invention is shown in FIG. 1. Computer 102 contains a processor 104 which controls the overall operation of computer 102 by executing computer program instructions which define such operation. The computer program instructions may be stored in a storage device 112 (e.g., magnetic disk) and loaded into memory 110 when execution of the computer program instructions is desired. Thus, the functions of the computer will be defined by computer program instructions stored in memory and/or storage and the computer will be controlled by processor 104 executing the computer program instructions. Computer 102 also includes one or more network interfaces 106 for communicating with other devices via a network. Computer 102 also includes input/output 108 which represents devices which allow for user interaction with the computer 102 (e.g., display, keyboard, mouse, speakers, buttons, etc.). One skilled in the art will recognize that an implementation of an actual computer will contain other components as well, and that FIG. 1 is a high level representation of some of the components of such a computer for illustrative purposes.

As will be discussed in further detail below, various data structures are used in various implementations of the invention. Such data structures may be stored electronically in memory 110 and/or storage 112 in well known ways. Thus, the particular techniques for storing the variously described data structures in the memory 110 and storage 112 of computer 102 would be apparent to one of ordinary skill in the art given the description herein, and as such the particular storage techniques will not be described in detail herein. What is important for purposes of this description is the overall design and use of the various data structures, and not the particular implementation for storing and accessing such data structures in a computer system.

In addition, various embodiments of the invention as described below rely on various data networking designs and architectures. What is important for an understanding of the various embodiments of the present invention is the network architecture described herein. However, the particular implementation of the network architecture using various data networking protocols and techniques would be well known to one skilled in the art, and therefore such well known protocols and techniques will not be described in detail herein.

Returning now to a description of an embodiment of the invention, the first step is to create an appropriate index scheme to allow for efficient range based queries on the multidimensional resource space. There are several types of tree structures that support multidimensional data access. Different index structures differ in the way they split the multidimensional data space for efficient access and the way they manage the corresponding data structure (e.g., balanced or unbalanced). Most balanced tree index structures provide O(logN) search time (where N is the number of nodes in the tree). However, updating these types of index structures is costly because maintaining the balance of the tree may require restructuring the tree. Unbalanced index structures do not have restructuring costs, yet in the worst case they can require O(N) search times.

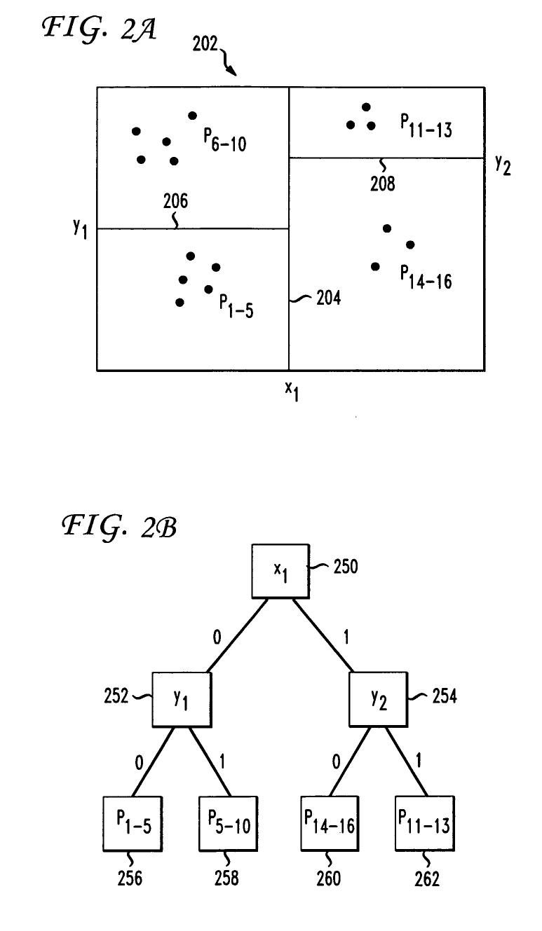

In one particular embodiment of the invention, a k-d tree is used as the logical data structure for the index. A k-d tree is a binary search tree which recursively subdivides the multidimensional data space into boxes by means of d-1 dimension iso-oriented hyper-planes. A two dimensional data space, along with the 2-d tree representing the data space, are shown in FIGS. 2A and 2B respectively. FIG. 2A shows a two dimensional data space 202 containing data points P₁₋₁₆ dispersed throughout the data space. The data points P₁₋₁₆ represent, for example, grid resources which are described using the model described above. The vertical line X₁ 204 and the horizontal lines Y₁ 206 and Y₂ 208 represent data evaluation divisions. For example, a resource discovery request in the two dimensional example may first require a decision as to whether the requested resource falls to the left or right of vertical line X₁ 204 in the space. If to the left, then the next decision is as to whether the requested resource falls above or below horizontal line Y₁ 206 in the space. If for example, a resource request is found to fall to the left of vertical line X₁ 204 and below horizontal line Y₁ 206 then any of the resources represented by data points P₁₋₅ would satisfy the user's ranged resource request.

FIG. 2B illustrates the 2-d tree data structure that may be used to logically represent the two dimensional data space shown in FIG. 2A. As described above, the storage of a 2-d data tree in a computer memory element (for example using linked lists and pointers) would be well known to one skilled in the art. The root node X₁ (250) represents a first evaluation of the resource request, and corresponds vertical line X₁ of FIG. 2A. Depending upon the evaluation at Node 250, either the left or right branch off of node 250 is traversed. This evaluation and tree traversal continues until a leaf node is reached. The leaf nodes store the multidimensional data points representing the grid system resources. One skilled in the art will readily recognize the relationship between FIGS. 2A and 2B.

Each of the nodes of the 2-d tree of FIG. 2B is named using a bit interleaving naming technique. That is, starting from the root node X₁ (250), “0” is assigned to the left branch and “1” is assigned to the right branch. Thus, node Y1 (252) is labeled “0” and node Y2 (254) is labeled “1”. Next, from node Y1 (252) the left branch is followed to node 256 and node 256 is labeled “00”. Again from node Y1 252 the right branch is followed to node 258 and node 258 is labeled “01”. Now, from node Y2 (254) the left branch is followed to node 260 and node 260 is labeled “10”. Again from node Y2 (254) the right branch is followed to node 262 and node 262 is labeled “11”. Thus, using this naming scheme, each node has a unique label based upon its location in the tree.

Thus, the above described 2-d data tree may be used as the index for a grid resource broker in order to evaluate ranged user resource request queries. However, as discussed above, a centralized index is not scalable, and therefore presents a problem for grid computing systems having a large number of resources and users. Thus, in order to handle user requests at a large scale, partitioning and distribution of the index is required. Thus, the logical index tree nodes must be mapped to, and stored on, physical network nodes. In accordance with an embodiment of the invention, the logical index tree is mapped to physical nodes using a distributed hash table (DHT) overlay technique. Generally, a DHT maps keys to physical network nodes using a consistent hashing function, for example SHA-1. In one advantageous embodiment, the logical index tree is mapped to physical nodes in accordance with the techniques described in I. Stoica, R. Morris, D. Karger, M. Kaashoek, H. Balakrishnan, Chord: A Scalable Peer-to-peer Lookup Service for Internet Applications, Proceedings of ACM SIGCOMM, Aug. 27-31, 2001, San Diego, Calif., which is incorporated herein by reference. This reference describes Chord, which is a distributed lookup protocol that maps a given key onto a network node. In the present embodiment, the key of a logical index tree is its unique label as assigned using the above described naming scheme. As described below, Chord maps these keys to physical network nodes.

Chord is used to provide fast distributed computation of a hash function mapping keys to the physical nodes responsible for storing the logical nodes identified by the keys. Chord uses consistent hashing so that the hash function balances load (all nodes receive roughly the same number of keys). Also when an N^{th} node joins (or leaves) the network, only an O(1/N) fraction of the keys are moved to a different location thus maintaining a balanced load.

Chord provides the necessary scalability of consistent hashing by avoiding the requirement that every node know about every other node. A Chord node needs only a small amount of “routing” information about other nodes. Because this information is distributed, a node resolves the hash function by communicating with a few other nodes. In an N-node network, each node maintains information only about O(log N) other nodes, and a lookup requires O(log N) messages. Chord updates the routing information when a node joins or leaves the network. A join or leave requires O(log²N) messages.

The consistent hash function assigns each physical node and key an m-bit identifier using a base hash function such as SHA-1. A physical node's identifier is chosen by hashing the node's IP address, while a key identifier is produced by hashing the key. The identifier length m must be large enough to make the probability of two nodes or keys hashing to the same identifier negligible.

Consistent hashing assigns keys to nodes as follows. Identifiers are ordered in an identifier circle modulo 2^{m}. A key k is assigned to the first node whose identifier is equal to or follows (the identifier of) k in the identifier space. This node is called the successor node of key k, denoted by successor (k). If identifiers are represented as a circle of numbers from 0 to 2^{m}- 1, then successor (k) is the first node clockwise from k.

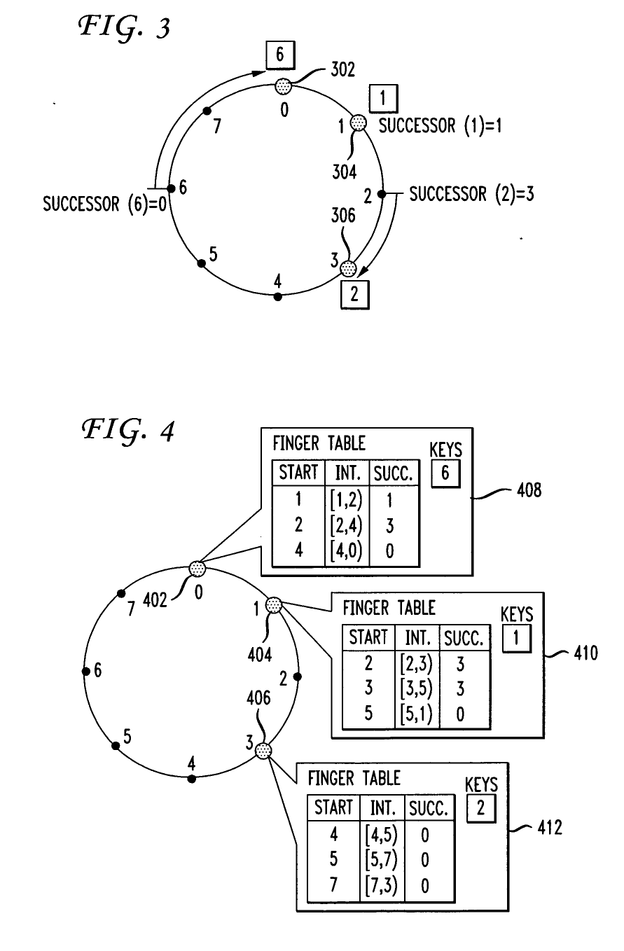

FIG. 3 shows an identifier circle with m=3. The circle has three nodes: 0 (302), 1 (304) and 3 (306). The successor of identifier 1 is node 1 (304), so key 1 would be located at node 1 (304). Similarly, key 2 would be located at node 3 (306), and key 6 at node 0 (302).

Consistent hashing is designed allow nodes to enter and leave the network with minimal disruption. To maintain the consistent hashing mapping when a node n joins the network, certain keys previously assigned to n's successor now become assigned to n. When node n leaves the network, all of its assigned keys are reassigned to n's successor. No other changes in assignment of keys to nodes need occur. In the example above, if a node were to join with identifier 7, it would capture the key with identifier 6 from the node with identifier 0.

Only a small amount of routing information suffices to implement consistent hashing in a distributed environment. Each node need only be aware of its successor node on the circle. Queries for a given identifier can be passed around the circle via successor pointers until the query first encounters a node that succeeds the identifier; this is the node the query maps to. A portion of the Chord protocol maintains these successor pointers, thus ensuring that all lookups are resolved correctly. However, this resolution scheme is inefficient as it may require traversing all N nodes to find the appropriate mapping. Chord maintains additional routing information in order to improve the efficiency of this process.

As before, let m be the number of bits in the key/node identifier. Each node n, maintains a routing table with (at most) m entries, called a finger table. The i^{th} entry in the finger table at node n contains the identity of the first node, s, that succeeds n by at least 2ⁱ⁻¹ on the identifier circle, i.e., s=successor (n+2ⁱ⁻¹), where 1<i<m (all arithmetic is modulo 2^{m}). Node s is called the i^{th} finger of node n A finger table entry includes both the Chord identifier and the IP address (and port number) of the relevant node. Note that the first finger of n is its immediate successor on the circle and is often referred to it as the successor rather than the first finger.

FIG. 4 shows example finger tables for the example nodes of FIG. 3. FIG. 4 shows an example finger table 408 for node 0 (402), an example finger table 410 for node 1 (404), and an example finger table 412 for node 3 (406). The finger table 410 of node 1 (404) points to the successor nodes of identifiers (1+2⁰) mod 2³=2, (1+2¹) mod 2³=3, and (1+2²) mod 2³=5, respectively. The successor of identifier 2 is node 3 (406) (as this is the first node that follows 2), the successor of identifier 3 is node 3 (406), and the successor of 5 is node 0 (402).

The Chord technique has two important characteristics. First, each node stores information about only a small number of other nodes, and knows more about nodes closely following it on the identifier circle than about nodes farther away. Second, a node's finger table generally does not contain enough information to determine the successor of an arbitrary key k. For example, node 3 (406) does not know the successor of 1, as 1's successor (Node 1) does not appear in Node 3's finger table.

Using the Chord technique, it is possible that a node n will not know the successor of a key k. In such a case, if n can find a node whose identifier is closer than its own to k, that node will know more about the identifier circle in the region of k than n does. Thus n searches its finger table for the node j whose identifier most immediately precedes k, and asks j for the node it knows whose identifier is closest to k. By repeating this process, n learns about nodes with identifiers closer and closer to k.

Further details of the Chord protocol may be found in the above identified reference, I. Stoica, R. Morris, D. Karger, M. Kaashoek, H. Balakrishnan, Chord: A Scalable Peer-to-peer Lookup Service for Internet Applications, Proceedings of ACM SIGCOMM, Aug. 27-31, 2001, San Diego.

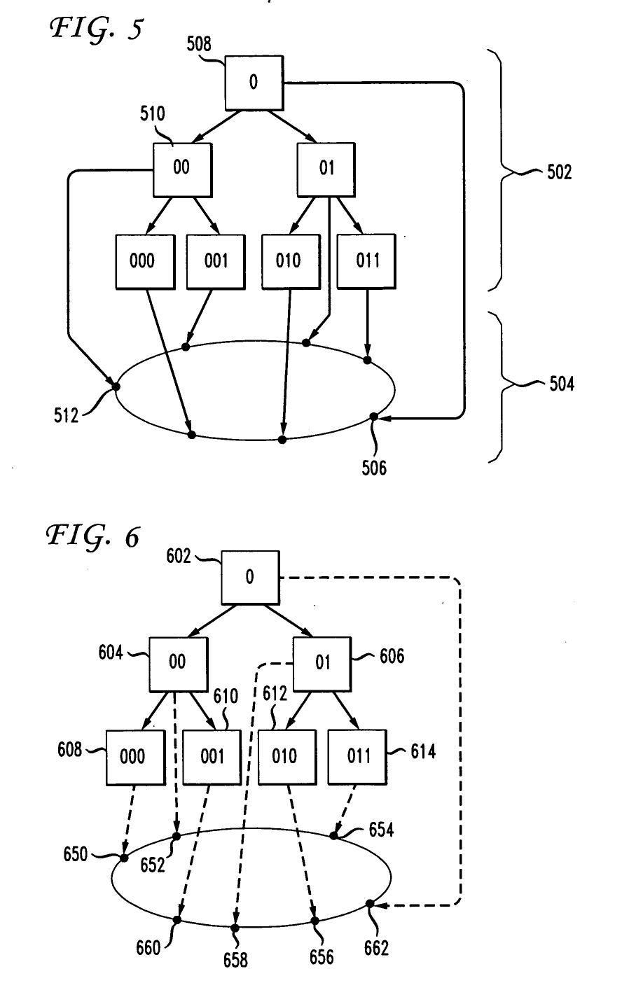

Thus, using a DHT technique, such as Chord, the nodes of the logical index tree are mapped to physical nodes in a distributed network. One technique for such mapping is to use the logical identification (e.g., the unique label of each node of the logical index tree) of a logical node as the key, and to use a DHT mapping technique to map the logical node to a physical node as described above. Such a mapping technique is shown in FIG. 5, which illustrates the mapping of the logical index tree 502 to distributed physical network nodes 504 using a DHT technique such as Chord. Each of the nodes of the logical index tree 502 are shown with their corresponding logical identification label. Arrows represent the mapping from a logical node to a corresponding associated physical network node at which the logical node is stored. For example, logical index tree node 510 having logical identifier (i.e., unique label) 00 is mapped to physical network Node 512. However, there is a problem with this basic mapping technique. The problem is that the workload among the physical nodes will not be balanced. For example, consider physical node 506 to which logical node 508 is mapped. Since logical node 508 is the root of the logical index tree, many queries will need to access this logical node, and therefore physical node 506 will get a very large number of hits.

In accordance with one aspect of the invention, the above described load balancing problem is solved by replicating the logical index tree nodes in the distributed physical nodes in the network. Three types of logical node replication are described below.

A first embodiment, referred to as tree replication, replicates the logical index tree in its entirety. In this embodiment, certain ones of the physical nodes contain replicas of the entire logical index data structure. Any search operation requiring access to the index must first reach one of these nodes replicating the index tree in order to access the index and find which physical nodes contain the leaves corresponding to the requested range. Note that in the context of grid computing resource brokering, only one point (physical resource) which lies within the query range (resource attribute constraints) needs to be found. Thus, unlike traditional range queries which retrieve all data points that fall within the range, in resource brokering only one such data point needs to be located.

Analysis shows that to achieve load scalability, the number of index replicas should be O(N), where N is the total number of nodes in the network. Assuming that, on average, each node generates c requests/sec, where c is a constant, then the total load per second (L) would be L=cN. If there are K index replicas, the load distribution would be O(N/K)=(O/N) on each physical node containing a replica. This means that each physical node should be aware of the entire index tree structure in order to have a constant load on the nodes. If each physical node contained a replica of the entire tree structure, then query look-up would be inexpensive. DHT look-ups would be needed only to locate matched labels. Since each DHT look-up costs O(logN), the total look-up cost using this tree replication technique is O(logN). In general, if there are K replicas, the search would requires O(logN) time to locate one of the K index nodes and O(logN) time to locate one of the matching nodes. Thus, the search requires O(logN) time. The lookup load in the index nodes is.

$$O ( \frac{N}{K} ) .$$

If a leaf node in the logical index tree is overloaded due to a skewed distribution of data points, then a split operation is required to split the leaf node into two nodes. A split operation introduces a transient phase into the network. This transient phase exists when the original leaf node L has been repartitioned into two new leaf nodes L₁ and L₂, but the re-partitioning has not yet been reported to all tree replicas. During this period, L has to redirect any query that incorrectly targets L to either one of the two new leaves L₁ and L₂. Overall, the cost of a node split is made up of two components: (1) required maintenance of the index tree data structure in order to split the original node into two new nodes and (2) the cost to propagate the updates to all index replicas in the network. If only leaf splitting is considered, without enforcing height-balancing of the tree, then propagation cost is the dominant factor. Any change to the tree structure has to be reported to all O(N) replicas, which is equivalent to a broadcast to the entire network. Hence the cost of each split is O(N). In general, if there are K replicas, the update requires O(Klog(N)) messages. In a grid computing network, available resources may change frequently, thus requiring frequent updates to the index structure. Thus, the tree replication technique in which the entire index tree is replicated in certain ones of the physical network nodes become expensive.

Examining the tree replication approach closely, it is noted that each node within the logical index tree is replicated in the physical nodes the same number of times (along with the entire index structure). This, however, is wasteful because the tree nodes lower in the tree are accessed less often than those higher in the tree. It is also noted that, in many tree index structures, lower nodes split more frequently. Reducing the amount of lower node replication will therefore reduce the update cost. The appropriate amount of replication should be related to the depth of the node in the tree. More precisely, assuming that the leaves are uniformly queried, the number of replicas of each node should be proportional to the number of the node's leaf descendants. The next two embodiments are based on this realization.

A second embodiment of replication is referred to as path caching. In this embodiment each physical node has a partial view of the logical index tree. This path caching technique constructs a single logical index tree and performs replication at the physical level as follows.

Consider the logical index tree shown in FIG. 6. Each tree node is assigned a unique identifier (i.e., label) using the above described naming technique. Root node 602 has label 0. Internal nodes 604 and 606 have labels 00 and 01 respectively. Leaf nodes 608, 610, 612 and 614 have labels 000, 001, 010 and 011 respectively. Each of the logical index nodes are mapped to physical nodes. FIG. 6 shows this mapping of logical index nodes to physical nodes using broken lines. Thus, for example, root node 602 is mapped to physical node 662. Internal nodes 604 and 606 are mapped to physical nodes 652 and 658 respectively. Leaf nodes 608, 610, 612 and 614 are mapped to physical nodes 650, 660, 656 and 654 respectively. Each logical node is stored in the physical node to which it is mapped. In addition, and in accordance with the path caching technique each internal node (including the root node) is replicated at all of the physical nodes to which its leaf descendants map. Stated another way, each physical node stores the logical index information about the entire path from the root to the leaf node that is mapped to it. Thus, for example, as shown in FIG. 6, leaf node 612 maps to physical node 656. Therefore leaf node 612 is stored in physical node 656. Further, all the logical nodes from the root 602 to leaf node 612 are replicated at physical node 656. Therefore, logical nodes 602 and 606 are replicated at physical Node 656.

The benefit of the path caching technique may be seen from the following example. A search traverses the logical tree until a node that matches the range query (i.e., a node that consists of points within the range) is reached. Assume that the node that matches the range query (i.e., the target node) is logical Node 614, which is stored at physical Node 654. A query is initially sent to any physical node. Assume in this example that the query is first sent to physical node 650 which stores logical Node 608. The query must then traverse from logical node 608 to logical node 614 via logical nodes 604, 602 and 606. If there were no path caching, then the search process must access physical nodes 652, 662, 658 in order to traverse logical nodes 604, 602, 606 respectively. However, using the fast path caching technique, physical node 650 which stores logical node 608 also stores replications of logical nodes 604 and 602. Thus, the search process does not have to access physical nodes 652 and 662.

It is noted that if it were necessary to access the corresponding physical node each time access to a target logical node was required, then load balancing would be lost. This is where replication through path caching helps. While the query is being routed towards the physical node to which the target logical node is mapped, it is hoped to reach a physical node at which a replica of the target logical node is stored. Thus, the physical node to which the target logical node is mapped will not necessarily be reached every time an access to the target logical node is required.

The efficiency of the path replication technique depends on the probability with which replicas are hit before reaching the target. Suppose the tree depth is h, and the level of the target node is k. The probability that one of the replicas will be hit before the target is hit is 1=(1=2^{-k})^{k}. This shows that if a target node is higher in the tree, the probability of hitting a replica of the target node is higher.

In a height-balanced tree, each search traverses the tree and each hop along the logical path is equivalent to a DHT lookup, and therefore incurs a DHT lookup cost. Thus the search cost is O(logN×logN)=O(log² N). In a non-height-balanced tree, however, the search cost is O(h×logN)=O(log² N), where 1≦h≦N is the height of the tree.

If height does not need to be balanced, then each logical node split only affects the current leaf node and the two nodes that are newly created, i.e. only two DHT lookups are needed. Hence, in this case, the total update cost is O(logN). If the height needs to be balanced, the update cost depends upon the degree of restructuring needed to maintain the multi-dimensional index structure. Even in the simplest case, where updates simply propagate from leaf to root, an update that affects the root would need to be communicated to all leaf nodes which are caching the root with the update cost being at least O(N).

Thus, there is a trade-off between the efficiency of the search and the efficiency of the updates. Since updates are common in grid computing resource brokering, O(N) update cost is not feasible and maintaining a height-balanced tree is not realistic. Instead, a non-height balanced tree, which gets fully restructured once the level of imbalance goes beyond a threshold, is an advantageous middle ground between the two strategies.

In accordance with a third embodiment, a node replication technique is used to replicate each internal node explicitly. In accordance with this technique, the node replication is done at the logical level itself. In this embodiment the number of replicas of any given logical node is proportional to the number of the node's leaf descendants. Thus, the root node will have N replicas (where N equals the number of leaf nodes) while each leaf node has only one replica. Stated another way, a node at tree level k will have N/2^{k} replicas.

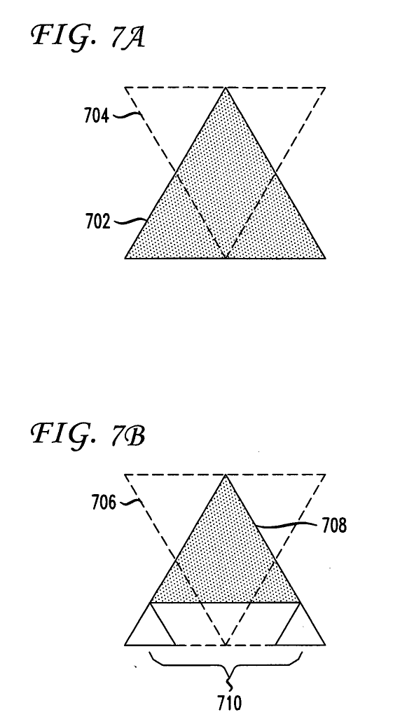

FIG. 7(a) shows a general representation of this embodiment. The filled triangle 702 represents the logical index tree, and the dashed triangle 704 represents the corresponding replication graph. The shape of 704 illustrates the degree of replication for each level of the search tree (i.e., N/2^{k} replicas at level k).

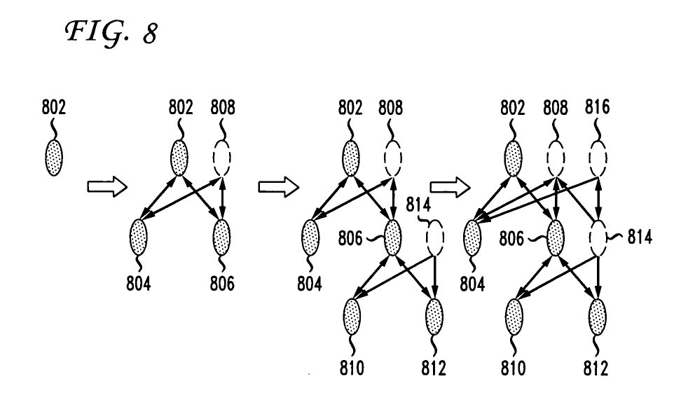

FIG. 7(b) is a graphical illustration showing how the replication graph evolves as the logical index tree expands. Note that since the number of times an internal node is replicated depends on the number of the corresponding leaf nodes, the creation of a new leaf node requires replication of all of its ancestors. 708 shows the original logical tree before expansion (i.e., 702). Assume that 710 represents new leaves added to expand the logical tree. Here, the replication 704 must also be expanded to 706. This process is illustrated in FIG. 8. In FIG. 8, the solid filled circles represent the logical index tree nodes, while the dashed circles represent the explicitly generated replica logical nodes. FIG. 8 shows a single root Node 802. Each time a node splits, one more replica for all the nodes along the path from the node to the root is created. Referring to FIG. 8, if tree root node 802 splits into leaf nodes 804 and 806, then replica node 808 is generated in order to have two replicas. Note that the two leaf nodes 804 and 806 share two replicas, 802 and 808, as their parent node. Assume now that node 806 splits into nodes 810 and 812. Since node 806 now has two leaf nodes, node 814 that replicates node 806 is generated. Also, node 802 now has three leaf nodes, so that it needs one more replica. Thus, node 816 is generated as a replica of Node 802.

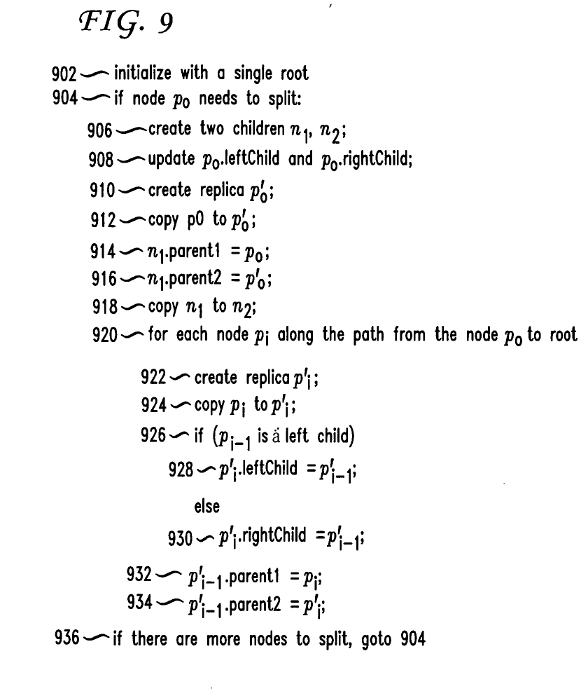

Pseudo code showing a computer algorithm to construct a replication graph is shown in FIG. 9 and will now be described in conjunction with the replication graph shown in FIG. 8. First, in step 902, the replication graph is initialized with a single root 802. Now assume that root node 802 needs to be split, and that the splitting requirement is determined in step 904, such that node 802 becomes node p₀ in the algorithm. Next, according to step 906, two child nodes n₁ and n₂ are created, corresponding to nodes 804 and 806. In step 908, the left and right child pointers of node p₀ 802 are updated to point to n₁ and n₂, 804 and 806 respectively. In step 910 replica node p′₀ 808 is created and in step 912 node p₀ 802 is copied to node p′₀ 808. Next, in steps 914 and 916 node n₁ 804 is updated to include an indication of its two parent nodes, p₀ 802 and p₀′808. In step 918, n₁ 804 is copied to n₂ 806 so that now node n₂ 806 also includes an indication of its two parent nodes, p₀ 802 and p₀′808. The loop starting with step 920 and including steps 922-934 will not be performed during this iteration because there are no nodes along the path from node p₀ 802 to the root (because node p₀ 802 itself is the root). Assuming there are more nodes to split, then the decision in step 936 will return control to step 904.

The loop starting with step 920 and including steps 922-934 performs replication of intermediary nodes of the tree starting from the leaf node p₀ up the path to the root node (i.e., nodes p₀, P₁, P₂, . . . ). During each iteration of the loop, a node pᵢ (i=1, 2, 3, . . . ) is processed. Steps 922 and 924 create the exact replica (as a new node p′ᵢ) of node pᵢ. Steps 926, 928 and 930 modify p′ᵢ so that it has node pᵢ₋₁ (i.e., a replica of pᵢ₋₁ created in the last iteration) as its child. Since a tree node must distinguish its two children (i.e., left child and right child), step 926 checks a condition: if pᵢ₋₁ is a left child of pᵢ, p′ᵢ₋₁ must also be a left child of p′ᵢ, if pᵢ₋₁ is a right child of pᵢ, p′ᵢ₋must also be a right child of p′ᵢ. Steps 932 and 934 set parents of node p′ᵢ₋₁ so that it can reach two replicas of the parent: node pᵢand node p′ᵢ.

Assume next that node 806 needs to be split, such that node 806 becomes node p₀ in the algorithm. Next, according to step 906, two child nodes n₁ and n₂ are created, corresponding to nodes 810 and 812. In step 908, the left and right child pointers of node p₀ 806 are updated to point to n₁ and n₂, 810 and 812 respectively. In step 910 replica node p′₀ 814 is created an in step 912 node p₀ 806 is copied to node p′₀ 814 . Next, in steps 914 and 916 node n₁ 810 is updated to include an indication of its two parent nodes, p₀ 806 and p₀′814. In step 918, n₁ 810 is copied to n₂ 812 so that now node n₂ 812 also includes an indication of its two parent nodes, p₀ 806 and p₀′814.

The loop starting with step 920 and including steps 922-934 will be performed for each node starting from 806 up to the root. In this case, only the root node (either 802 or 808) needs to be processed. Assume 808 is taken as the node to be processed (it can be chosen randomly) from the two alternatives. Thus, steps 922-934 are performed for i=1 and pᵢ= node 808. In step 922, a replica p′₁ (Node 816) is created. In step 924, data of node 808 is copied to node 816. Accordingly, at this time, node 816 has node 804 as its left child and node 806 as its right child (which are exactly the same child nodes as node 802). In step 926, the algorithm checks that node 806 is a right child of node 808 (i.e., the condition is FALSE). This means that new replica 816 must have node 814 as its right child. Thus, in step 930, a right child of node 806 (p′ᵢ) is set as node 814 (p′ᵢ₋₁). Having a new parent node 806 that replicates Node 808, steps 932 and 934 set parents of node 814 as nodes 808 and 816.

In this explicit replication technique, the replication graph is created in the logical space. All the logical nodes are mapped to physical space as described above using the DHT technique. Note that each node maintains information about at most four other nodes (its two parents and its left child and right child). Whenever a query traverses along the tree path, each node randomly picks one of its two parents for routing in the upward direction. Thus, the load generated by the leaves are effectively distributed among the replicas of the internal nodes. Since each internal node is replicated as many times as the corresponding leaves, an overall uniform load distribution is achieved.

In a height-balanced tree, each search traverses the tree once upward and then downward and each hop along the logical path is equivalent to a DHT lookup and incurs a DHT lookup cost. Thus, the search cost is O(logN×logN)=O(log² N). In a non-height-balanced tree, however, the search cost is O(h×logN)=O(log² N), where 1≦h≦N is the height of the tree.

If the height does not need to be balanced, then each logical node split involves creating one more replicas for each node along the path from leaf to the root. Hence, the update cost is O(log² N). The advantage of this scheme is that if the height needs to be balanced and updates need to propagate from leaf to root, this affects only one path from leaf to root, and thus the update cost will still be O(log² N). Thus, in an environment, (such as grid computing resource brokering) where updates are frequent, this technique performs well for a height-balanced tree providing a good trade-off between searches and updates.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A system comprising:
a plurality of distributed network nodes;
each of said network nodes storing at least a portion of a logical index tree;
said logical index tree comprising a plurality of logical nodes;
wherein said logical nodes are mapped to said network nodes based on a hash function.

2. The system of claim 1 wherein each of said logical nodes is stored at least in the network node to which it is mapped.

3. The system of claim 1 wherein at least one of said network nodes stores all nodes of the logical index tree.

4. The system of claim 1 wherein each of said network nodes stores 1) a logical node which maps to the network node and 2) the logical nodes on a path from said logical node to a root node.

5. The system of claim 1 wherein:
said logical index tree further comprises replicated logical nodes; and
each of said network nodes stores the logical nodes which map to the network node.

6. The system of claim 1 wherein said logical nodes of said logical index tree map keys to values.

7. The system of claim 6 wherein said keys comprise a plurality of resource attributes and said values represent addresses of resources.

8. A method comprising:
maintaining a logical index tree comprising a plurality of logical nodes;
storing at least a portion of said logical index tree in a plurality of distributed network nodes; and
mapping said logical nodes to said network nodes based on a hash function.

9. The method of claim 8 further comprising the step of:
storing logical nodes in at least the network nodes to which they map.

10. The method of claim 8 wherein said step of storing comprises storing the entire logical index tree in at least one of said network nodes.

11. The method of claim 8 wherein said step of storing comprises the steps of:
storing a logical node in the network node to which said logical node maps; and
storing the logical nodes on a path from said logical node to a root node in said network node.

12. The method of claim 8 wherein:
said step of maintaining a logical index tree comprises replicating logical nodes; and
said step of storing comprises storing the logical nodes of said logical index tree in the network nodes to which said logical nodes map.

13. A grid computing resource discovery system comprising:
a logical index tree comprising a plurality of logical nodes for indexing available resources in said grid computing system,
a network of distributed broker nodes for assigning grid computing resources to requesting users, each of said distributed broker nodes storing at least a portion of said logical index tree;
wherein said logical nodes are mapped to said broker nodes based on a distributed hash function.

14. The system of claim 13 herein each of said logical nodes is stored at least in the broker node to which it maps.

15. The system of claim 13 wherein at least one of said broker nodes stores all of said logical nodes.

16. The system of claim 13 wherein each of said broker nodes stores: 1) logical leaf nodes which map to the broker node and 2) logical nodes on paths from said logical leaf nodes to a root node.

17. The system of claim 13 wherein:
said logical index tree further comprises replicated logical nodes; and
each of said broker nodes stores the logical nodes which map to the broker node.

18. The system of claim 13 wherein said logical nodes map keys to values.

19. The system of claim 18 wherein said keys comprise a plurality of grid computing resource attributes and said values represent network addresses of grid computing resources.
